(19) United States
(12) Patent Application Publication
(10) Pub. No.: US 2025/0382099 A1
(43) Pub. Date: Dec. 18, 2025

(54) Folding Luminous Gift Box

(71) Applicant: Jialun Ying, Taizhou (CN)

(72) Inventor: Jialun Ying, Taizhou (CN)

(21) Appl. No.: 18/770,726

(22) Filed: Jul. 12, 2024

(30) Foreign Application Priority Data
Jun. 12, 2024 (CN) 202421335689.9

(51) Int. Cl. B65D 21/08; B65D 25/20; B65D 63/00

(52) U.S. Cl. CPC B65D 21/086; B65D 25/20; B65D 63/00; B65D 2203/00; B65D 2313/02

(57) ABSTRACT

A folding luminous gift box includes a top structure, a side structure, a rotating shaft and a light emitting component; one side of the top structure is rotatably connected with one side of the side structure through the rotating shaft, the top structure and the side structure can be opened or closed mutually, the top structure and the side structure together enclose one cavity; the light emitting component is arranged in the cavity and includes multiple light emitting diodes and a connecting wire, the multiple light emitting diodes are connected in series through the connecting wire. This gift box has functions of light emitting and folding, which can be used at night or in dim environments. It has a wide range of usage scenarios, simplifies installation process and improves installation efficiency.

### CROSS-REFERENCE TO RELATED APPLICATIONS

The present application claims the benefit of Chinese Patent Application No. 202421335689.9 filed on Jun. 12, 2024, the contents of which are hereby incorporated by reference.

### TECHNICAL FIELD

The present application relates to a technical field of gift boxes, in particular to a folding luminous gift box.

### BACKGROUND

A gift box is a box used for wrapping gifts or serving as a decoration. It usually has a decorative and attractive appearance. Gift boxes can be designed and decorated according to different themes and occasions to show unique personality and style.

Since an integral gift box takes up a large space and is easily crushed during transportation, assembled gift boxes were designed. Currently, the common assembled gift boxes are composed of multiple scattered parts, which need to be spliced and glued together according to the instructions. The installation steps are relatively cumbersome, and the gift box can only be used during the day. If it is used at night or in dim environment, the gift box will lose its decorative effect and attraction, resulting in limitations in its usage scenarios.

### SUMMARY

In order to overcome the shortcomings of the prior art, the present application provides a folding luminous gift box, which has functions of light emitting and folding, can be used at night or in dim environments, has a wide range of usage scenarios, and also simplifies the installation process and improves installation efficiency.

The technical solution adopted by the present application to solve its technical problems is:
a folding luminous gift box, including a top structure, a side structure, a rotating shaft and a light emitting component; wherein one side of the top structure is rotatably connected with one side of the side structure through the rotating shaft; the top structure and the side structure can be opened or closed mutually, the top structure and the side structure together enclose one cavity; the light emitting component is arranged in the cavity and includes a plurality of light emitting diodes and a connecting wire, the plurality of the light emitting diodes are connected in series through the connecting wire.

As a further improvement of the above technical solution, the connecting wire is tied to the top structure and the side structure.

As a further improvement of the above technical solution, a plurality of cable ties are arranged on the top structure and the side structure, and the connecting wire passes through the plurality of the cable ties.

As a further improvement of the above technical solution, the side structure and the top structure respectively include a support frame and a decorative surface, wherein the decorative surfaces are connected on the support frames.

As a further improvement of the above technical solution, the decorative surfaces are made of silk thread, cloth or plastic board.

As a further improvement of the above technical solution, a decorative strip is arranged on the decorative surfaces, the decorative surface of the top structure is detachably tied with a decorative object.

As a further improvement of the above technical solution, the top structure's decorative surface and the decorative object are tied with a hook-and-loop fastener, an outer surface of the decorative surface is provided with a hook surface of the hook-and-loop fastener, a bottom of the decorative object is provided with a loop surface of the hook-and-loop fastener.

As a further improvement of the above technical solution, a joint position of the top structure and the side structure away from the rotating shaft is connected through a fastener.

As a further improvement of the above technical solution, the support frames of the top structure and the side structure are both provided with support pieces, the support piece of the top structure is arranged as a crossed support frame, and the support piece of the side structure is arranged as a straight support frame.

As a further improvement of the above technical solution, the side structure comprises a first side surface, a second side surface, a third side surface and a fourth side surface, a tail end of the first side surface is movably connected with a head end of the second side surface, a tail end of the second side surface is movably connected with a head end of the third side surface, a tail end of the third side surface is movably connected with a head end of the fourth side surface, a tail end of the fourth side surface is fastened and connected with a head end of the first side surface.

The beneficial effects achieved by the present application are:

The present application provides a folding luminous gift box, including a top structure and a side structure, which can be installed by simply closing the top structure and the side structure, simplifying the installation process and improving the installation efficiency. At the same time, the gift box is also provided with a light emitting component, which can be used at night or in a dim environment and has a wide range of usage scenarios.

### BRIEF DESCRIPTION OF DRAWINGS

FIG. 1 is a schematic diagram of a support frame in the folding luminous gift box of the present application;

FIG. 2 is a connection schematic diagram of A in FIG. 1;

FIG. 3 is a schematic diagram of the expansion of a support frame in the folding luminous gift box of the present application;

FIG. 4 is an overall schematic diagram of the folding luminous gift box of the present application;

FIG. 5 is a connection schematic diagram of a decorative object in a folding luminous gift box of the present application.

### NOTE OF THE REFERENCE SIGNS

1—top structure; 10—crossed support frame; 11—connecting hook; 12—cable tie;

2—side structure; 20—straight support frame; 21—rotating shaft; 22—connecting hole; 201—first side surface; 202—second side surface; 203—third side surface; 204—fourth side surface;

3—light emitting component; 30—connecting wire; 31—light emitting diode;

40—decorative surface; 41—decorative strip; 410—hook surface of the hook-and-loop fastener; 42—decorative object; 420—loop surface of the hook-and-loop fastener.

### DESCRIPTION OF EMBODIMENTS

The following will clearly and completely describe the concept, specific structure and technical effects of the present application in combination with the embodiments and figures, so as to fully understand the purpose, characteristics and effects of the present application. Obviously, the described embodiments are only one part of the embodiments of the present application, rather than all of them. Based on the embodiments of the present application, other embodiments obtained by technicians in this field without creative work are all within the scope of protection of the present application. In addition, all the connection relationships involved in the application do not refer to the direct connection of components, but refer to the formation of a better connection structure by adding or reducing connection accessories according to the specific implementation situation. The various technical features in the creation of the present application can be combined interchangeably without conflicting with each other.

The present application provides a folding luminous gift box, including a top structure 1 and a side structure 2. The installation can be achieved by simply closing the top structure 1 and the side structure 2, which simplifies the installation process and improves the installation efficiency. At the same time, the gift box is also provided with a light emitting component 3, which can be used at night or in a dim environment and has a wide range of usage scenarios.

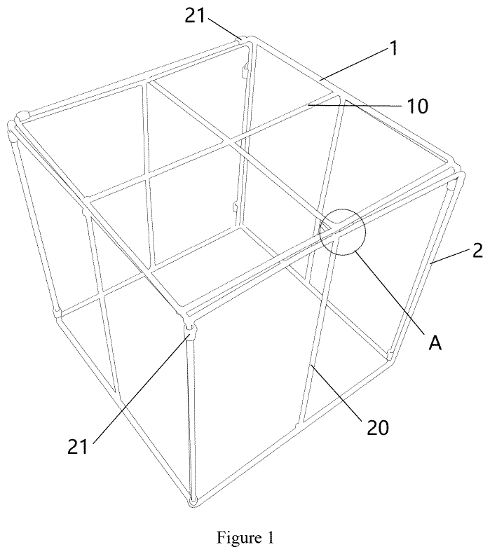

Referring to FIGS. 1 to 5, the present embodiment provides a folding luminous gift box, including a top structure 1, a side structure 2, a rotating shaft 21 and a light emitting component 3.

One side of the top structure 1 is rotatably connected to one side of the side structure 2 through the rotating shaft 21. The top structure 1 and the side structure 2 can be opened or closed with each other. The top structure 1 and the side structure 2 are capable of enclosing one cavity. The light emitting component 3 is arranged in the cavity and includes a plurality of light emitting diodes 31 and a connecting wire 30. The plurality of the light emitting diodes 31 are connected in series through the connecting wire 30. The plurality of the light emitting diodes 31 are provided with pins, and the connecting wire 30 is welded to the pins. The connecting wire 30 is connected to an external power supply device.

In one implementation method, a bottom of the gift box is unobstructed, and the connecting wire 30 can extend along the bottom to an outside of the gift box and be connected to an external power supply device to power the light emitting diodes 31.

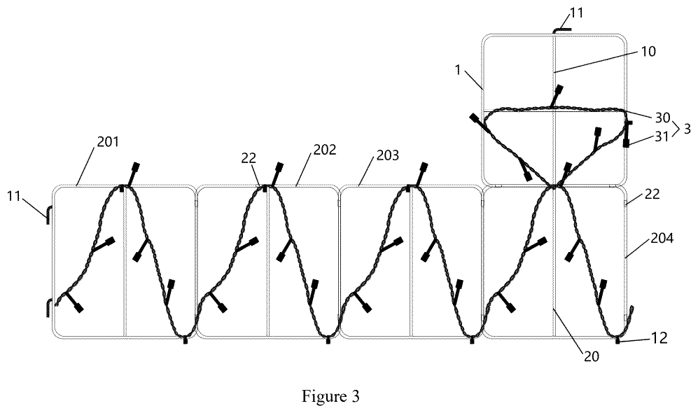

Referring to FIG. 3, in one implementation method, the connecting wire 30 is tied to the top structure 1 and the side structure 2, and when the light emitting component 3 is powered on, the light generated by the light emitting diodes 31 is evenly distributed on the gift box. In another specific implementation method, the light emitting component 3 can be directly stacked in the cavity, and when the light emitting component 3 is powered on, the light generated by the light emitting diodes 31 diffuses from a middle of the cavity to a periphery of the gift box.

Further referring to FIG. 3, in one implementation method, the top structure 1 and the side structure 2 both include a support frame, and a plurality of cable ties 12 are arranged on the support frame. The plurality of the cable ties 12 are used for fixing the connecting wire 30. Specifically, one end of the connecting wire 30 is tied to the support frame, and other end of the connecting wire 30 passes through the plurality of the cable ties 12 in sequence, and then extends to the outside of the gift box to be connected to the power supply equipment.

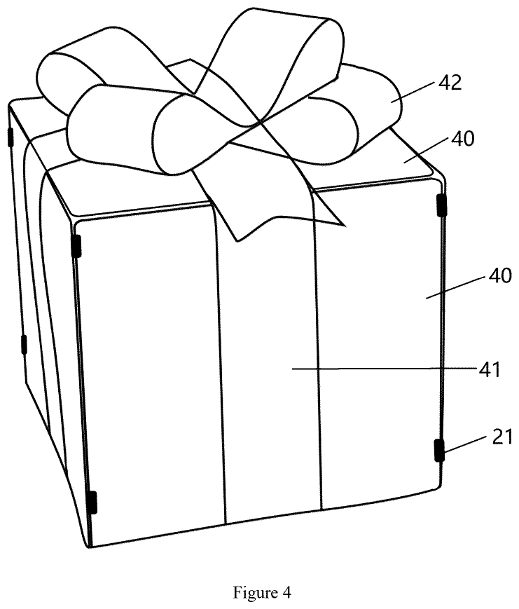

Referring to FIG. 4, furthermore, both the top structure 1 and the side structure 2 further include a decorative surface 40, which is arranged on the support frame. The decorative surface 40 is used for decorating an appearance of the gift box, and the user can replace the decorative surface 40 according to the usage scenario, which provides the user with a personalized choice. The support frame can be reused multiple times and is applicable to a wide range of scenarios.

In this embodiment, the decorative surface 40 is made of cloth, and the cloth is glued to the support frame by glue. Since the cloth has good light transmittance, it will not affect a lighting effect of the light emitting component 3.

In another implementation method, the decorative surface 40 can be made of a plastic board or a silk thread, wherein the silk thread is designed into a mesh structure for easy light transmission, and the plastic board has good light transmittance and will not affect the lighting effect of the light emitting component 3.

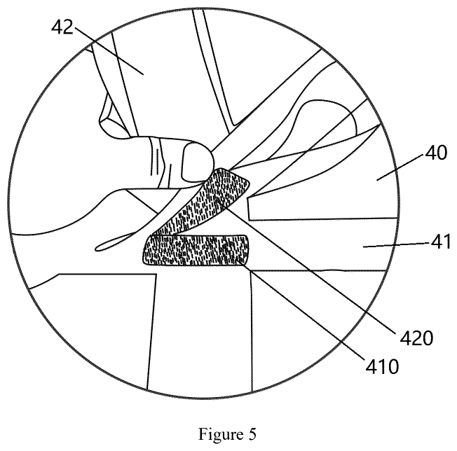

Referring to FIGS. 4 and 5, in one implementation method, a decorative strip 41 is arranged on the decorative surface 40, and the decorative strip 41 is wrapped around an outer surface of the decorative surface 40 to increase an ornamental value of the gift box.

In one implementation method, the decorative surface 40 of the top structure 1 is detachably tied with a decorative object 42. Referring to FIG. 4, the decorative object 42 in this embodiment is a bowknot, and the user can replace it with other decorative objects 42 according to preference. Specifically, the decorative object 42 is connected to the decorative strip 41 of the top structure 1 through a hook-and-loop fastener, and an outer surface of the decorative strip 41 of the top structure 1 is provided with a hook surface of the hook-and-loop fastener 410, and a bottom of the decorative object 42 is provided with a loop surface of the hook-and-loop surface 420.

In another implementation method, a fastening connection structure or a magnetic connection structure may be used between the decorative object 42 and the decorative surface 40.

Referring to FIG. 1, in one implementation method, the support frames of the top structure 1 and the side structure 2 are both provided with a support piece, which provides supporting function for the gift box and increase the stability of the gift box. Specifically, the support piece on the top structure 1 is arranged as a cross support frame 10, and the support piece of the side structure 2 is arranged as a straight support frame 20.

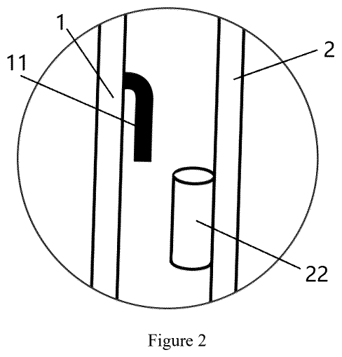

Referring to FIGS. 1 and 2, in one implementation method, a joint position of the top structure 1 and the side structure 2 away from the rotating shaft 21 is connected through a fastener. Specifically, a connecting hook 11 is arranged on the top structure 1, and a connecting hole 22 is arranged on the side structure 2. The connecting hook 11 matches with the connecting hole 22 to connect the covered top structure 1 and the side structure 2, so as to prevent the gift box from falling apart during use.

Referring to FIG. 3, in one implementation method, the side structure 2 includes a first side surface 201, a second side surface 202, a third side surface 203, and a fourth side surface 204, the tail end of the first side surface 201 is movably connected to the head end of the second side surface 202, the tail end of the second side surface 202 is movably connected to the head end of the third side surface 203, the tail end of the third side surface 203 is movably connected to the head end of the fourth side surface 204, and the tail end of the fourth side surface 204 is fastened and connected to the head end of the first side surface 201. In this embodiment, the movable connection refers to a rotating shaft connection, and two of the connected side surfaces can be rotated to different angles.

Since the side structure 2 in this embodiment includes four side surfaces, when the gift box is assembled, the four side surfaces are enclosed to form a quadrilateral column, and the top structure 1 is configured as a quadrilateral structure that matches the quadrilateral column.

In another implementation method, the side structure 2 may include three or more than four side edges to enclose columns of different structures, thereby presenting different gift box effects.

Referring to FIG. 3, for the convenience of description, it is assumed that the rotating shaft 21 is arranged at a top of the fourth side surface 204, and the top structure 1 is connected to the rotating shaft 21. Correspondingly, when the top structure 1 is closed on the side structure 2, the top structure 1 is connected to the second side surface 202 through a fastener. When the gift box needs to be used, the side structure 2 is first enclosed into a quadrilateral column, the first side surface 201 and the fourth side surface 204 are connected through a fastener, and then the top structure 1 is covered on a top of the quadrilateral column, and finally the top structure 1 is connected to the second side surface 202 through a fastener, so as to realize the assembly of the gift box, and the installation steps are simple and convenient for users to use; when the gift box is not needed to be used, the side structure 2 and the top structure 1 are folded together for storage, which can reduce the occupied space and is not easily crushed during transportation and storage.

It can be understood that, under the guidance of the above embodiments, those skilled in the art can combine various implementation methods in the above embodiments to obtain a technical solution of multiple implementation methods.

The above description is only a preferred embodiment of the present application and is not intended to limit the present application. Any modifications, equivalent substitutions and improvements made within the spirit and principles of the present application should be involved in the protection scope of the present application.

1. A folding luminous gift box, comprising a top structure, a side structure, a rotating shaft and a light emitting component;
wherein one side of the top structure is rotatably connected with one side of the side structure through the rotating shaft; the top structure and the side structure can be opened or closed mutually, the top structure and the side structure together enclose one cavity;
wherein the light emitting component is arranged in the cavity and comprises a plurality of light emitting diodes and a connecting wire, the plurality of the light emitting diodes are connected in series through the connecting wire.

2. The folding luminous gift box according to claim 1, wherein the connecting wire is tied to the top structure and the side structure.

3. The folding luminous gift box according to claim 1, wherein a plurality of cable ties are arranged on the top structure and the side structure, the connecting wire passes through the plurality of the cable ties.

4. The folding luminous gift box according to claim 1, wherein the side structure and the top structure respectively comprise a support frame and a decorative surface, wherein the decorative surfaces are connected on the support frames.

5. The folding luminous gift box according to claim 4, wherein the decorative surfaces are made of silk thread, cloth or plastic board.

6. The folding luminous gift box according to claim 4, wherein a decorative strip is arranged on the decorative surfaces, the decorative surface of the top structure is detachably tied with a decorative object.

7. The folding luminous gift box according to claim 6, wherein the top structure's decorative surface and the decorative object are tied with a hook-and-loop fastener, an outer surface of the decorative surface is provided with a hook surface of the hook-and-loop fastener, a bottom of the decorative object is provided with a loop surface of the hook-and-loop fastener.

8. The folding luminous gift box according to claim 1, wherein a joint position of the top structure and the side structure away from the rotating shaft is connected through a fastener.

9. The folding luminous gift box according to claim 4, wherein the support frames of the top structure and the side structure are both provided with support pieces, the support piece of the top structure is arranged as a crossed support frame, and the support piece of the side structure is arranged as a straight support frame.

10. The folding luminous gift box according to claim 1, wherein the side structure comprises a first side surface, a second side surface, a third side surface and a fourth side surface;
wherein a tail end of the first side surface is movably connected with a head end of the second side surface, a tail end of the second side surface is movably connected with a head end of the third side surface, a tail end of the third side surface is movably connected with a head end of the fourth side surface, a tail end of the fourth side surface is fastened and connected with a head end of the first side surface.
